(19) United States
(12) Patent Application Publication
(10) Pub. No.: US 2015/0149302 A1
(43) Pub. Date: May 28, 2015

(54) METHOD AND SYSTEM FOR UNIFYING WORKFLOW PROCESSES FOR PRODUCING ADVERTISEMENT CONTENT

(71) Applicant: WAYVE LTD., London (GB)

(72) Inventor: JAMIE ANDREW JOHN PARKER, London (GB)

(73) Assignee: WAYVE LTD., London (GB)

(21) Appl. No.: 14/091,151

(22) Filed: Nov. 26, 2013

(51) Int. Cl. G06Q 30/02; G06F 3/0486

(52) U.S. Cl. CPC G06Q 30/0276; G06F 3/0486
USPC 705/14.72

(57) ABSTRACT

Methods and systems for generating device-optimized content from source data. The method and system include computing hardware which is operable to execute one or more software products for providing a graphical user interface for enabling user-manipulation of the source data to generate intermediate content. In addition, the method and system include a translation arrangement for translating the intermediate content to the device-optimized content. The translation arrangement takes into account rendering characteristics of one or more wireless-enabled portable rendering devices on which the device-optimized content is to be rendered.

### TECHNICAL FIELD

The present disclosure generally relates to creating advertisement content and, in particular, relates to a method and system for unifying workflow processes for producing advertisement content.

### BACKGROUND

In today's Internet era, there has arisen a digital advertising industry which is growing rapidly. There are different formats of digital advertisements which include, but not limited to, banners to half pages to advertisements, hereinafter “ad”, that appear over content, for example in a manner of overlays. As content consumption has increased at a rapid pace in contemporary society, advertisers need to deliver compelling ad experiences across different devices having mutually different specifications, mutually different screen sizes, mutually different operating systems and mutually different hardware capabilities, for example in respect of data memory capacity, accelerometer sensor and gyroscopic sensors. Examples of these devices include, but may not be limited to, desktop computers, laptop computers, personal digital assistants (PDA) and mobile phones; mobile telephones are also known as “cell phones”.

Content publishers prepare bespoke solutions for each device group and platform. For example, a company X not only has a responsive website allowing its content to be viewed using an optimized layout across different screen sizes/browser resolutions, but also has native apps for phones and tablet computers across different operating platforms, for example operating platforms created using mutually different software products such as iOS and Android.

A process for producing ad content begins with an approved flat design, which is often a native layered graphics editor file. This file is converted into optimized individual assets. A developer uses html/CSS code to incorporate these assets into a layout and then enrich functionality of the layout with features such as video, image galleries and 360 VR. The layout is then used as a basis for individual versions for devices, operating systems (OS) and publishing platforms. Resulting software code is adapted for each variation before being tested on relevant platforms. Moreover, content of the layout needs to be adapted for one or more additional screen size. Such adaptation requires restarting a process for generating the software code, but using some of the existing code elements as a starting point.

Most of these ads that run on desktop and laptop computing devices are authored using Flash, namely a proprietary technology from Adobe. However, some of the operating systems of the mobile phones do not support authoring on Flash. These mobile devices support only HTML based technologies such as HTML5.

Owing to a rapid continuous growth in large numbers of devices having mutually different screen sizes, specifications, and operating platform, it becomes very difficult to guarantee that content is displayed in an acceptable manner across all of the devices. This results in additional testing workload for parties generating content including ads. In addition, the lack of rich HTML5 authoring tools causes workflow processes for producing advertising content more complex. Such complexities present a large barrier from an advertiser, media and creative agency perspective. Advertisers want high impact creative, media agencies want the best possible reach and creative agencies want to achieve a best campaign performance for a given advertiser.

In a typical creative agency, ad content is designed using a graphical editing package, for example using proprietary Adobe Photoshop, before being sent to an advertiser for feedback and approval. Once approved, a production team at the creative agency manually ‘cuts’ their overall design up and splits individual layers/elements into optimized assets, for example in a JPG/PNG format. This process consumes considerable time and effort. In addition, there are tools that enable designers/developers to create a basic layout, for example for an ad. These tools offer limited functionality and require additional manipulation of source code. Moreover, these tools do not provide an ability to generate code for richer content such as image galleries linked to a device accelerometer/gyroscope, data capture forms and video. Such ability requires the developer to add custom code. Furthermore, when the ad content needs to be adapted to other screen sizes, the developer works alongside a designer to re-optimize assets for each screen size. The developer has to adapt manually the ad/content code to suit the new screen size. At times, the developer has to start over again, for example from a blank canvas, using some existing code/libraries.

Further, some approaches use ‘responsive’ design and fixed formats for advertising content. However, these approaches rely on template systems which require considerable upfront human resource initially to build and adapt the individual content elements to work within a given template. In addition, these approaches do not provide a degree of creative flexibility required by designers/developers.

In view of aforementioned problems associated with known approaches, there is a need for a method and a system which makes processes of authoring, testing and trafficking ad content simpler. In addition, the method and system beneficially unify workflow processes for producing ad content across desktop, mobile and future smart TV platforms.

### BRIEF SUMMARY

The present disclosure provides a method and system for generating device-optimized content from source data.

In an aspect of the present disclosure, a system having computing hardware which is operable to execute one or more software products for providing a graphical user interface for enabling user-manipulation of source data to generate intermediate content is provided. The system includes a translation arrangement for translating the intermediate content to corresponding device-optimized content. The translation arrangement takes into account rendering characteristics of one or more wireless-enabled portable rendering devices on which the device-optimized content is to be rendered.

In an embodiment of the disclosure, the source data includes camera-captured images of real scenes and/or objects. The system enables one or more simulated renderings of the device-optimized content on the graphical user interface. The one or more simulated renderings employ the translation arrangement for their generation.

In an embodiment, the system is operable to adapt the translation arrangement to simulate the one or more devices from rendering tests performed on one or more actual examples of the one or more devices. In addition, the system is operable to implement the rendering tests by performing physical image capture of one or more physical displays of the one or more devices and/or by performing a screen graphics capture of display data to be output to the physical displays of the one or more devices.

In an embodiment, the system provides a free-design graphical interface environment for entering the source data on the graphical user interface. The free-design graphical interface enables a “drag-and-drop” functionality for manipulating the source data. In an embodiment, the system is operable to accommodate the source data input as Adobe Flash content and/or HTML content. In addition, the system is operable to unify advert generation from the source data across a plurality of presentation platforms represented by the one or more devices. Moreover, the system is operable to perform repurposing of screen content for the different presentation platforms. Furthermore, the system automatically provides implementing tracking events and complete advertisements as the device-optimized content. The system is operable to optimize the source data automatically into JPG and/or PNG formats. The system is operable to allow workflow processes for simulated preview devices, for enabling users to control previews directly from a desktop environment provided at the graphical user interface. The system is operable intelligently to reposition objects on differing screen sizes and/or for differing browser resolution associated with the one or more devices. The graphical user interface provided by the system accommodates editing of one or more layouts of individual and/or multiple components on design canvas when generating the device-optimize content.

In an embodiment, the translation arrangement is automatically updated from the rendering tests. In addition, the translation arrangement is operable to generate software applications (“apps”) with embedded content for presentation as the device-optimized content.

In another aspect of the present disclosure, a method for generating device-optimized content from source data is provided. The method includes using a system having a computing hardware which is operable to execute one or more software products for providing a graphical user interface for enabling user-manipulation of the source data to generate intermediate content. In addition, the method includes a translation arrangement for translating the intermediate content to the device-optimized content which takes into account rendering characteristics of one or more wireless-enabled portable rendering devices on which the device-optimized content is to be rendered.

In an embodiment of the present disclosure, the method includes presenting one or more simulated renderings of the device-optimized content on the graphical user interface. The one or more simulated renderings employ the translation arrangement for their generation.

In an embodiment of the present disclosure, the method includes adapting the translation arrangement to simulate the one or more devices from rendering tests performed on one or more actual examples of the one or more devices. In addition, the method includes implementing the rendering tests by performing physical image capture of one or more physical displays of the one or more devices and/or by performing a screen graphics capture of display data to be output to the physical displays of the one or more devices. Moreover, the method includes generating the graphical user interface to provide a free design graphical interface environment for entering the source data using the system. Furthermore, the method includes operating the system to provide on the free-design graphical interface a “drag-and-drop” functionality for manipulating the source data. Furthermore, the method includes accommodating the source data input as Adobe Flash content and/or HTML content using the system. Furthermore, the method includes operating the translation arrangement to generate software applications (“apps”) with embedded content for presentation as the device-optimized content. Furthermore, the method includes performing repurposing of screen content for the different presentation platforms. Additionally, the method includes automatically implementing tracking events and complete advertisements as the device-optimized content.

In addition, the method includes using the system to optimize the source data automatically into JPG and/or PNG formats. Furthermore, the method includes allowing workflow processes for simulated preview devices, for enabling users to control previews directly from a desktop environment provided at the graphical user interface. Furthermore, the method includes intelligently repositioning objects on differing screen sizes and/or for differing browser resolution associated with the one or more devices. Furthermore, the method includes operating the system for accommodating on the graphical user interface editing of one or more layouts of individual and/or multiple components on design canvas when generating the device-optimize content.

In an embodiment of the present disclosure, the method includes automatically updating the translation arrangement from the rendering tests.

In yet another aspect of the present disclosure, a software product recorded on non-transient machine-readable data storage media is provided. The software product is executable upon computing hardware for implementing a method explained above.

Additional aspects, advantages, features and objects of the present disclosure would be made apparent from the drawings and the detailed description of the illustrative embodiments.

It will be appreciated that features of the disclosure are susceptible to being combined in various combinations or further improvements without departing from the scope of the disclosure and this provisional application.

### DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is an illustration of a system for generating device optimized content from a source data, in accordance with various embodiments of the present disclosure;

FIG. 2 is an illustration of different components of a communication device, in accordance with various embodiments of the present disclosure;

FIG. 3A, FIG. 3B, FIG. 3C and FIG. 3D are illustrations of sample screenshots showing extraction of layers, in accordance with various embodiments of the present disclosure;

FIG. 4A, FIG. 4B, FIG. 4C, and FIG. 4D are illustrations of sample screenshots showing addition of rich components to a canvas, in accordance with various embodiments of the present disclosure;

FIG. 5A, FIG. 5B, FIG. 5C and FIG. 5D are illustrations of sample screenshots of the platform showing registration of different communication devices, in accordance with various embodiments of the present disclosure;

FIG. 6 is an illustration of different previews of different ad contents and different ad formats on a communication device, in accordance with various embodiments of the present disclosure;

FIG. 7A, FIG. 7B, FIG. 7C, and FIG. 7D are illustrations of sample screenshots of repositioning of pasted objects for differing screen sizes/browser resolutions of different communication devices, in accordance with various embodiments of the present disclosure;

FIG. 8A, FIG. 8B and FIG. 8C are illustrations of sample screenshots of contextually display component actions menu on devices which have touch capabilities, in accordance with various embodiments of the present disclosure;

FIG. 9A, FIG. 9B and FIG. 9C are illustrations of sample screenshots of editing layout of an individual/multiple component objects on the canvas; in accordance with various embodiments of the present disclosure;

FIG. 10A, FIG. 10B and FIG. 10C are illustrations of sample screenshots of animating elements via a timeline user interface, in accordance with various embodiments of the present disclosure; and

FIG. 11 is an illustration of sample screenshots of enabling a user with an ability to load shared versions provided by other users, in accordance with various embodiments of the present disclosure.

### DESCRIPTION OF EMBODIMENTS

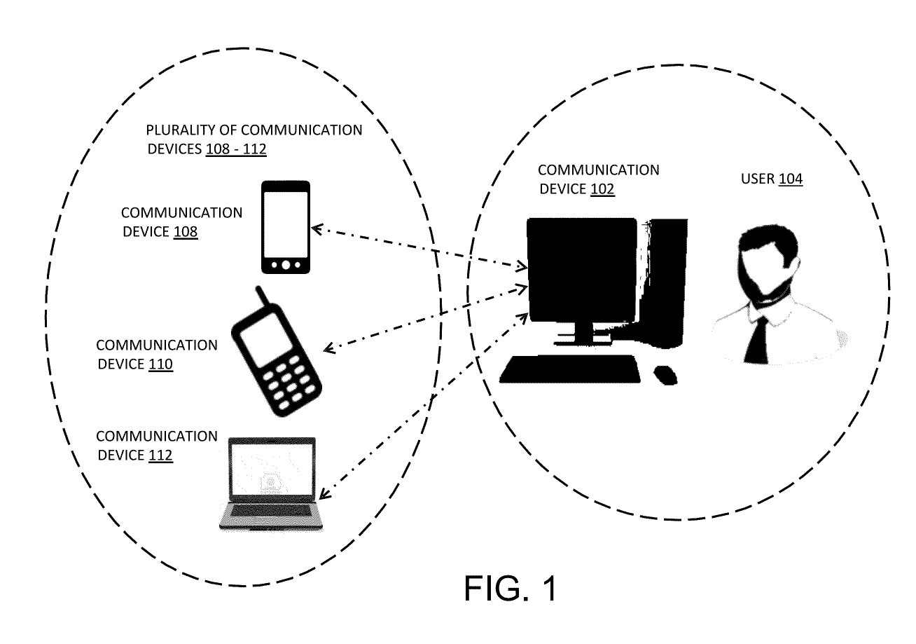

Referring now to the aforesaid drawings, particularly with reference to their reference numbers, FIG. 1 is an illustration of a system 100 for generating device-optimized content from source data, in accordance with various embodiments of the present disclosure. The system 100 includes a communication device 102 operated by a user 104. The user 104 is optionally a coder, a programmer, a tester, and/or a designer. The user 104 operates on the communication device 102 which enables creating, testing, managing and delivering of ad experiences across mutually different communication devices having mutually different specifications, screen sizes, different operating systems and mutually different hardware capabilities such as memory, accelerometer and gyroscopes.

The communication device 102 provides a set of tools for the user 104 which enables creating content appropriate for a communication device 108, the communication device 108 and a communication device 110, hereinafter collectively referred to as ‘plurality of communication devices 108-112’ or ‘the communication devices 108-112’. For example, each of the communication device 108, the communication device 110 and the communication device 112 belong to a group/genre of devices. This group of devices has:
(i) mutually different operating platforms, for example, android, iOS, BADA, and the like;
(ii) mutually different specifications, for example, graphics;
(iii) mutually different screen sizes, for example mutually different display screens; and
(iv) mutually different hardware capabilities such as memory, accelerometer and gyroscopes.
   Examples of the communication devices 108-112 include, but are be limited to, desktop, laptops, personal digital assistant (PDA) and mobile phones.

The set of tools collectively unifies the workflow process for producing ad content across desktop, mobile and future smart TV platforms. The unification of workflow process enables media agencies a best possible reach with highly impactful creative content within a shorter span of time across different groups of the communication devices 108-112. It may be noted that the FIG. 1 is shown to have the communication devices 108-112 having different operating platforms, specifications, and the like; however, those skilled in the art will appreciate that the communication device 102 having a set of tool enables production of ad content for multiple communication devices having mutually similar or different operating platforms, specifications, and the like.

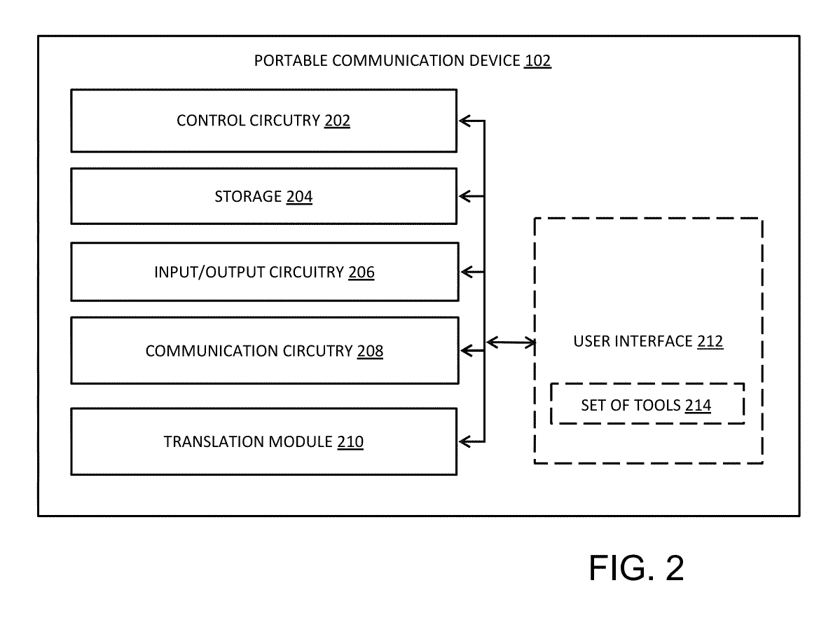

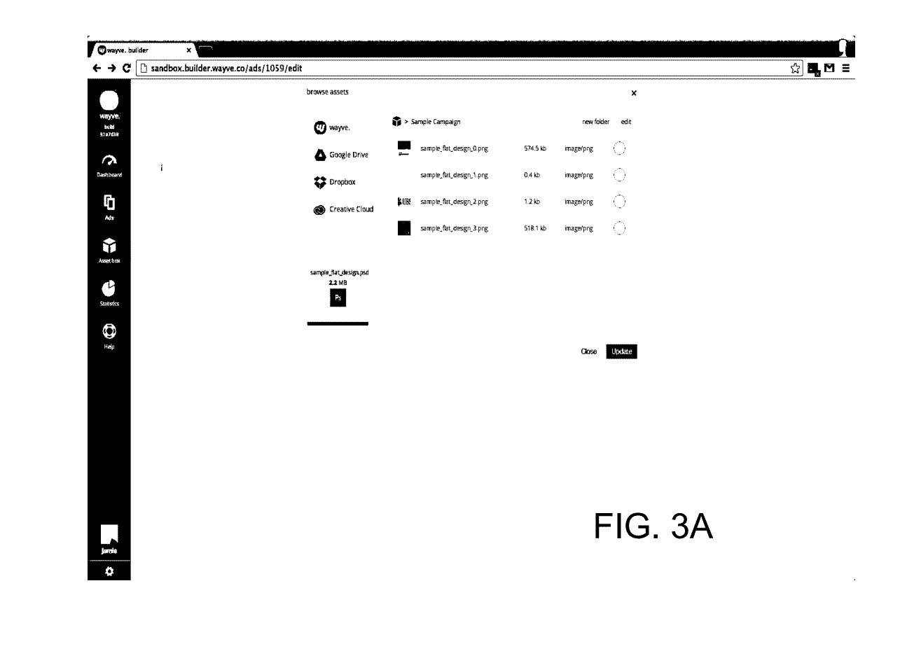

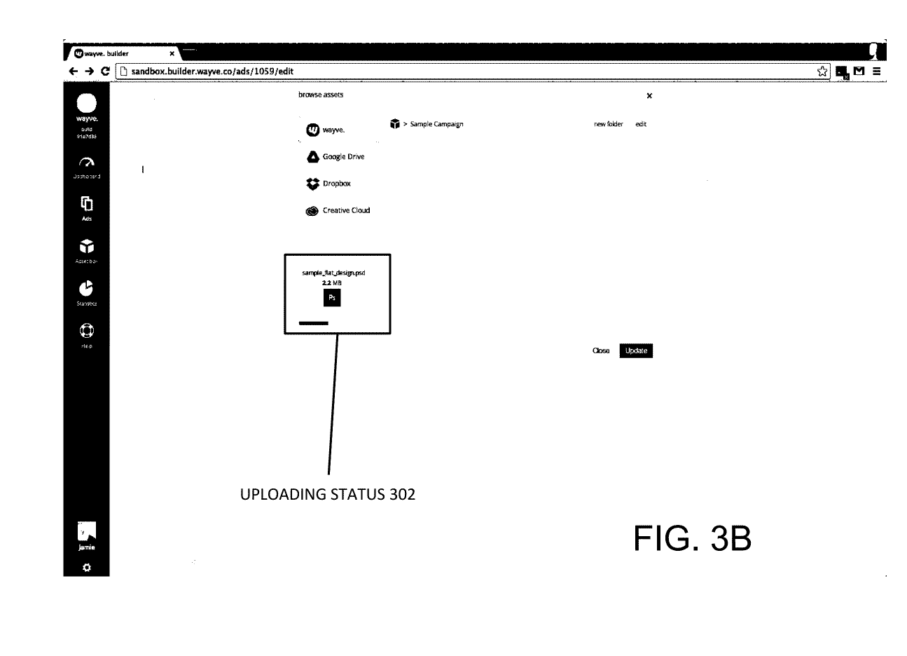

FIG. 2 is an illustration of different components of the communication device 102, in accordance with various embodiment of the present disclosure. The communication device 102 includes a control circuitry module 202, a storage module 204, an input/output (“I/O”) circuitry module 206, a communication circuitry module 208, and a translation module 210. From the perspective of this disclosure, the control circuitry module 202 includes any processing circuitry or processor operative to control the operations and performance of the communication device 102. For example, the control circuitry module 202 is optionally used to execute operating system applications, firmware applications, media playback applications, media editing applications, or any other application. In an embodiment of the present disclosure, the control circuitry module 202 drives a display and process inputs received from a user interface.

From the perspective of this disclosure, the storage module 204 includes one or more storage mediums including a hard-drive, solid state drive, flash memory, permanent memory such as ROM, any other suitable type of storage component, or any combination thereof. The storage module 204 stores, for example:
(i) media data, for example music and video files;
(ii) application data, for example for implementing functions on a portable communication device 136.
   Similarly, the I/O circuitry module 206 is operative to convert, and encode/decode if necessary, analog signals and other signals into digital data. In an embodiment, the I/O circuitry module 206 converts digital data into any other type of signal, and vice-versa. Similarly, the communications circuitry module 208 includes any suitable communications circuitry which is operative to connect to a communications network and to transmit communications, for example voice or data, from the communication device 102 to other devices within the communications network. The communications circuitry 208 is operative to interface with the communications network using any suitable communications protocol. Examples of the communications protocol include, but are not be limited to, Wi-Fi, Bluetooth®, radio frequency systems, infrared, LTE, GSM, GSM plus EDGE, CDMA, and quadband.

In an embodiment of the present disclosure, the control circuitry module 202, the storage module 204, the input/output (“I/O”) circuitry module 206 and the communication circuitry module 208 enables the user 104 to generate an intermediate content from a source data. In addition, the translation module 210 in conjunction with the control circuitry module 202, the storage module 204, the input/output (“I/O”) circuitry module 206 and the communication circuitry module 208 enables execution of one or more software products for providing a graphical user interface 212. In an embodiment of the present disclosure, the graphical user interface 212 provides a free-design graphical interface environment for entering the source data. In an embodiment of the present disclosure, the free-design graphical interface is a “drag-and-drop” functionality for manipulating the source data.

In an embodiment of the present disclosure, the source data input is Adobe Flash content. In another embodiment of the present disclosure, the source data input is HTML content.

The graphical user interface 212 provides the user 104 with a set of tools 214 for enabling manipulation of the source data to generate intermediate content. Once the intermediate content is created, the translation module 210 translates the intermediate content to the optimized content for each of the communication devices 108-112. The translation module 210 collects rendering characteristics of each of the communication devices 108-112. In an embodiment of the present disclosure, the rendering characteristics of each of the communication devices 108-112 are stored in the storage module 204. The translation module 210 translates the intermediate content to the optimized content for each of the communication devices 108-112 based on the respective rendered characteristics stored in the storage module 208.

The user 104 interacts with the set of tools 214 provided on the graphical user interface 212 and reduces workflow for production of the ad content for the communication devices 108-112. In an embodiment of the present disclosure, the set of tools 214 enables automatic asset optimization from layered graphics editing files such as adobe Photoshop. In addition, the set of tools 214 provides the user 104 with “drag and drop” functionality for rich content components. Moreover, the set of tools 214 provides the user 102 to preview controller of each of the communication devices 108-114 on the communication device 102. This live device preview controller via web application aids in the design and testing of the ad content for each of the communication devices 108-112. Moreover, the set of tools 214 enables the intelligent repurposing of ad content for mutually different sizes of the displays of each of the communication devices 108-112. For example, the set of tools 214 enables the intelligent repurposing of ad content for each of the communication devices 108-112 based on their respective size of displays. The user 104 optionally has to generate ad content once. This ad content is automatically customized by screen size of the mutually different communication devices 108-112. In an embodiment, the sizes of displays of the mutually different communication devices 108-112 are stored in the storage module 204. In an embodiment of the present disclosure, the source data includes camera-captured images of real scenes and/or objects.

In an embodiment of the present disclosure, the set of tools 214 intelligently updates component settings in real time, namely animation properties, when components are moved on canvas. In other words, the user 104 does not have to adjust an array of properties because the component's position is updated by the set of tools 214.

In an embodiment of the present disclosure, a platform enables the set of tools 214 to function. The platform on which the tools 214 function does code adaptation for the ad which needs to be published for each of the communication devices 108-112. This platform reduces the complexities in the workflow as well as the number of steps followed for testing the ad content to be published on each of the communication devices 108-112.

Typically, as described above in the background section, the ad content is designed using a graphical editing package, such as Adobe Photoshop, before being sent to an advertiser for feedback and approval. Once approved, the production team at the creative agency manually cut their overall design up and split the individual layers/elements into optimized assets, for example in JPG/PNG format. In addition, there are tools that enable designers/developers to create a basic layout. These tools offer limited functionality and require additional manipulation of the source code. Moreover, these tools do not provide the ability to generate code for richer content such as image galleries linked to device accelerometer/gyroscope, data capture forms and video. This requires the user 104 to add the custom code. Furthermore, when the ad content needs to be adapted to other screen sizes, the user 104 works alongside the designer to re-optimize assets for each screen size. The user 104 manually adapts the ad/content code to suit the new screen size. At times, the developer has to start over again by using a blank canvas and by using some existing code/libraries. In an embodiment, the platform of the present disclosure along with the set of tools 214 unifies the stated process and provides additional functional features. The platform is optionally a web-based platform.

In an embodiment of the present disclosure, the platform automatically implements tracking events for each component and ad as a whole. In addition, the platform enables the user 104 to share the preview of the ad content and content format with the client. For example, an ad agency hires a content developer/programmer to prepare content as well as an ad format for an advertiser. The platform enables the content developer/programmer to show the preview of the ad format on the different communication devices 108-110. In addition, the platform enables the ability to share campaigns/ad content with other team members for collaboration. For example, the user 104 shares the ad content, along with the format on the different communication devices 108-112, with other team members and seeks their feedback.

In an embodiment of the present disclosure, the platform generates relevant integration code for the one or more destination devices on which the ad needs to be published. For example, if the advertisement needs to be published on the communication device 108 having an android platform, a particular display size, a particular hardware specification, the platform generates relevant integration code in the ad format so that the ad can be published on a group of devices having a same configuration as that of the communication device 108. In addition, the platform configures tracking data and facilitates simple embedding of third party tracking tags. Moreover, the platform enables rich analytics displayed in context of ad content. The analytics data is overlaid onto relevant component objects.

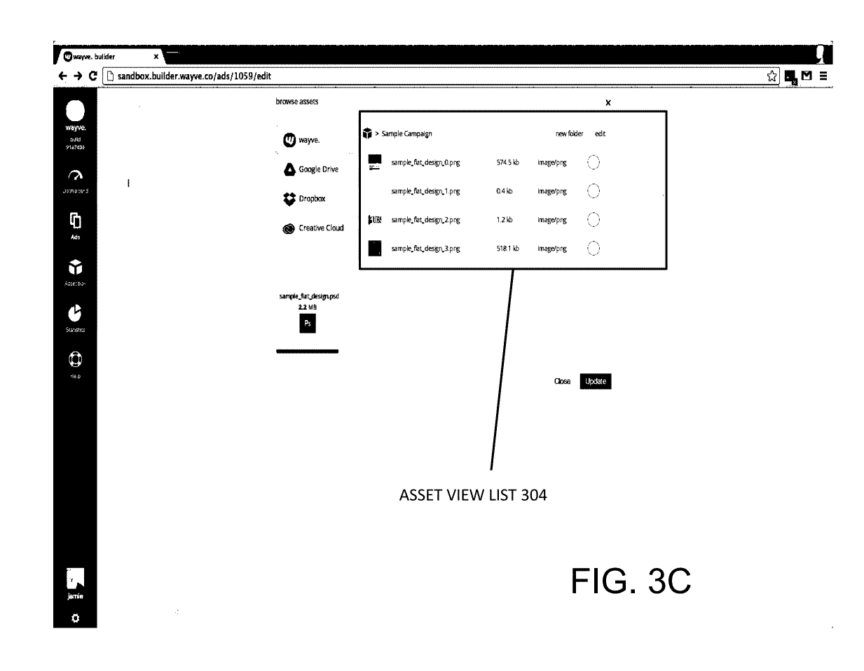

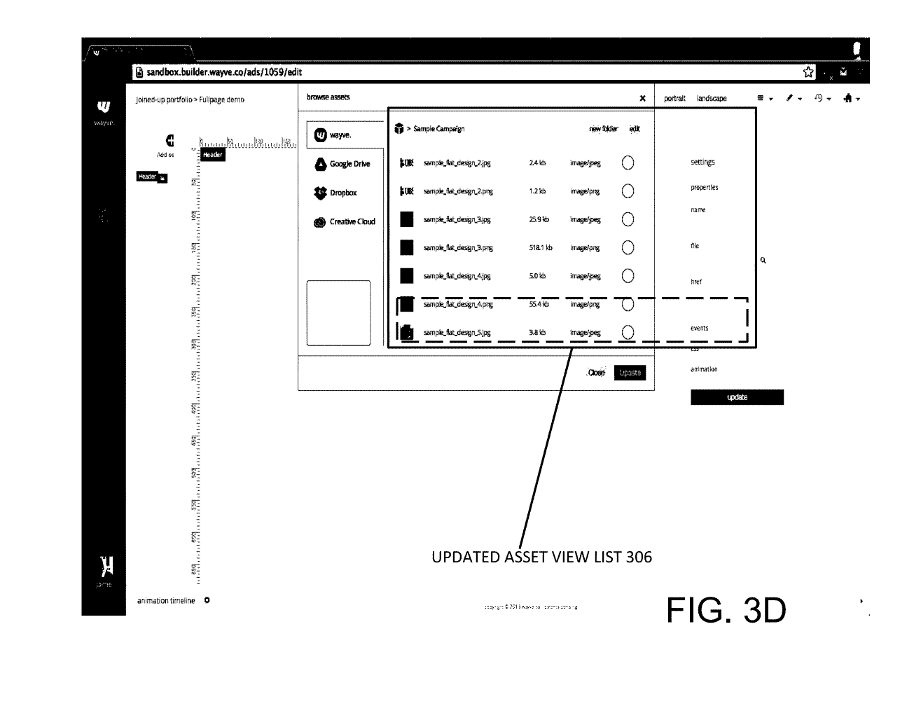

As described above and shown in FIG. 3A, FIG. 3B, FIG. 3C and FIG. 3D, the platform enables extraction of layers from PSD/PDF files to optimize JPG/PNG files for the ad which needs to be published. This conversion of traditional media files like PSD/PDF into the optimized digital format and file size e.g. in JPG and/or PNG allows a user to import traditional publisher files and bring them directly into the system 100. These optimized JPG/PNG files are then ready for use in new creations such as media campaigns or similar on the World Wide Web via e.g. HTML5 or similar coded language. Referring to FIG. 3A, a snapshot provides an illustration of the user 104 uploading layered file to the toolset 214 using an asset browser. FIG. 3B shows a sample snapshot illustrating uploading status 302 of the files to the platform in the user interface 212 having set of tools 214. As shown in FIG. 3C and FIG. 3D, once the file is uploaded, the platform automatically optimizes assets into both JPG and PNG format and are stored as available assets in a memory space allocated for the user 104. An asset list view 304 is refreshed as the individual optimized assets become available. FIG. 3D illustrates an updated asset list view 306.

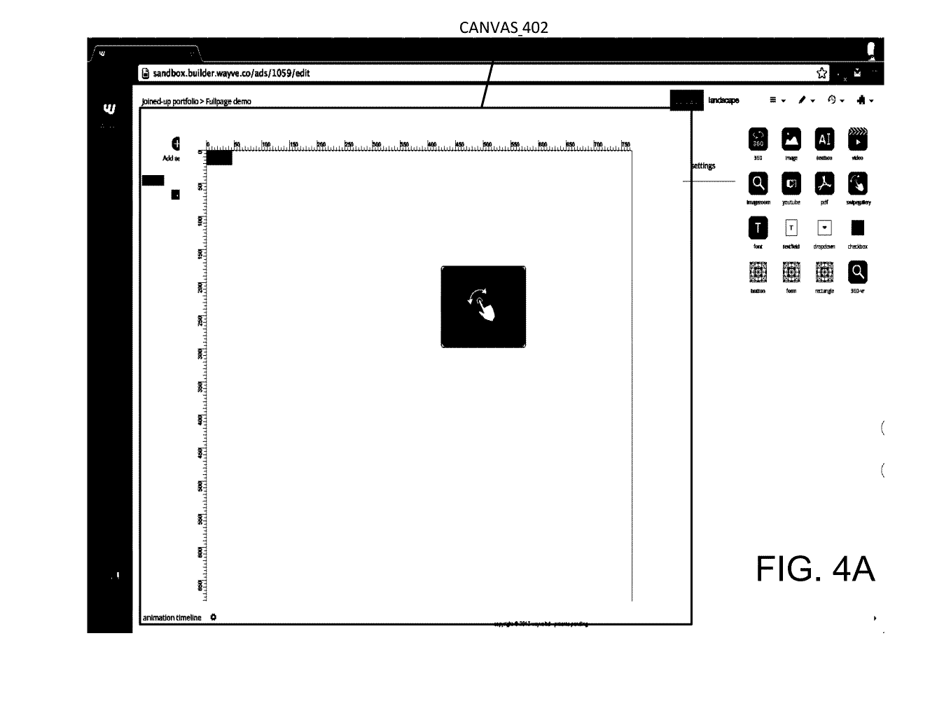

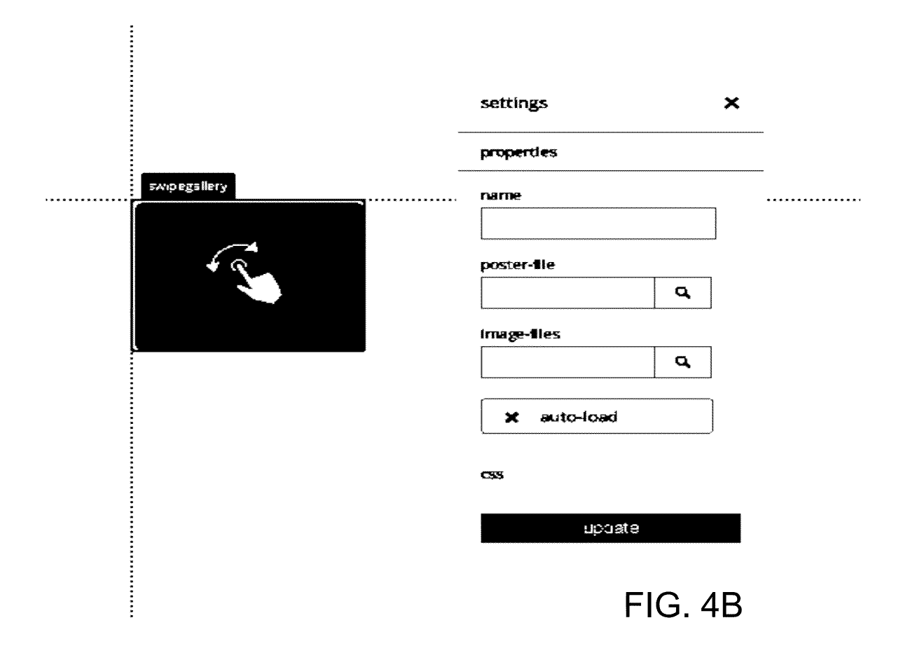

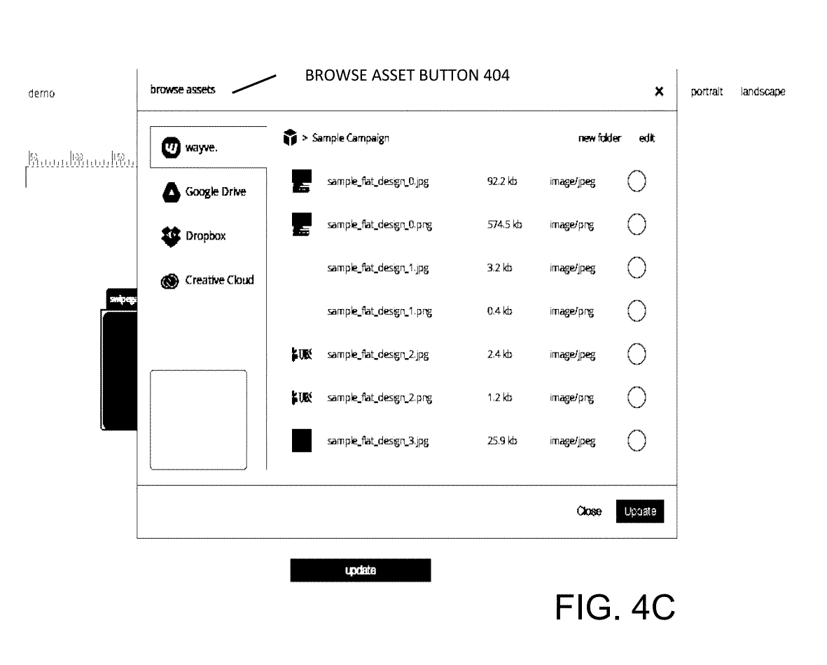

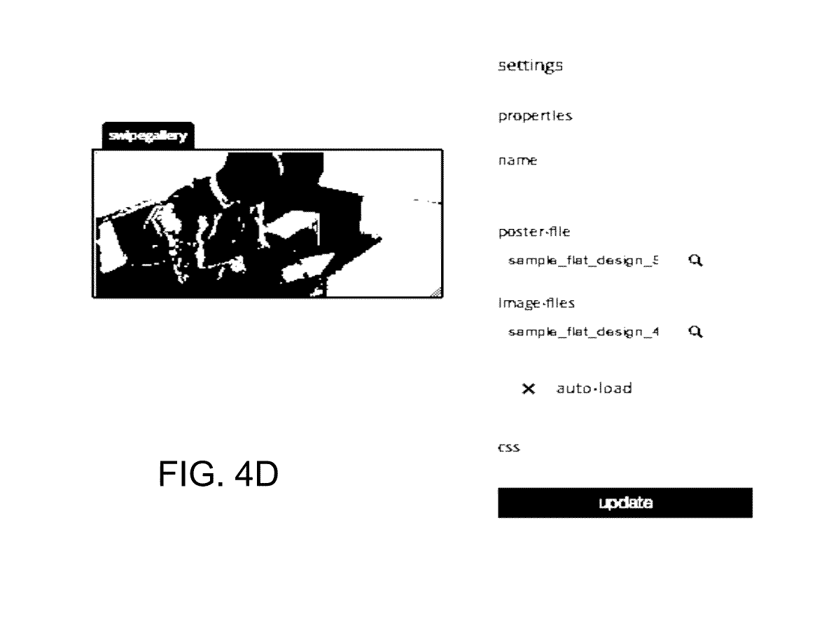

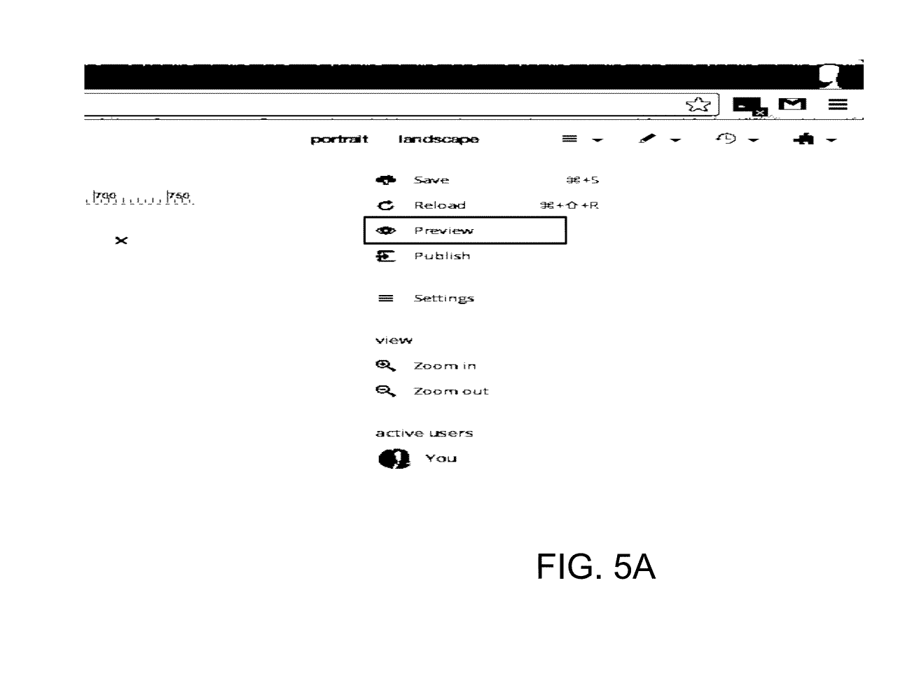

On the same lines, as described above, the platform, using the set of tools 214 on the user interface 212 of the communication device 102, enables the user 104 to add rich components to a canvas 402. As shown in a sample screen shot provided in FIG. 4A, the user 104 clicks on component navigation item and drags the desired component onto a given position on the canvas 402. In addition, as shown in the sample screenshots in FIG. 4B, the user 104 can customize component settings via the properties modal. The user 104 can select the assets by clicking on the ‘asset browse buttons’ shown in the sample screenshot provided in the FIG. 4C. Accordingly, asset box browser modal opens when the user 104 clicks on an ‘asset browse button 404’.

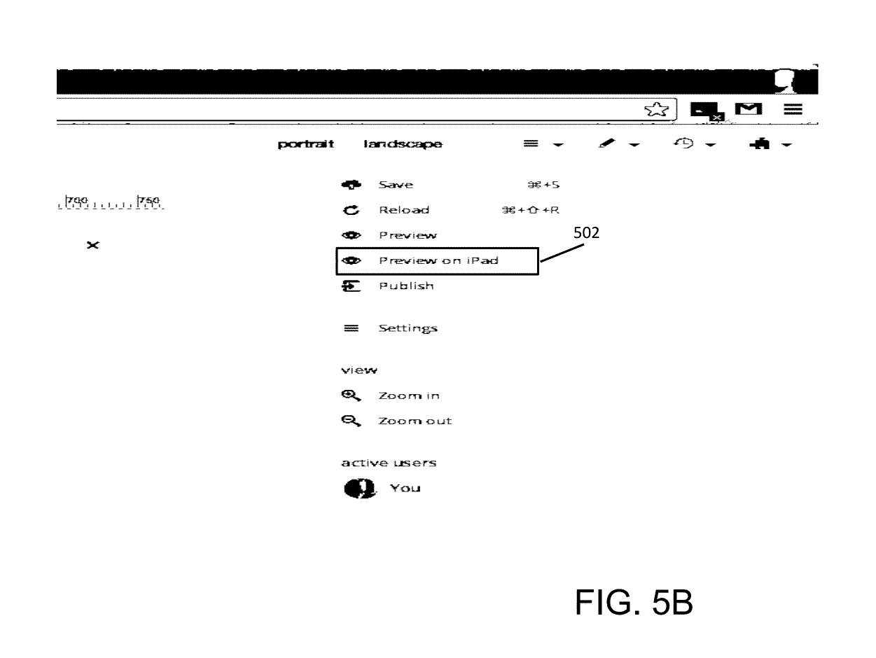

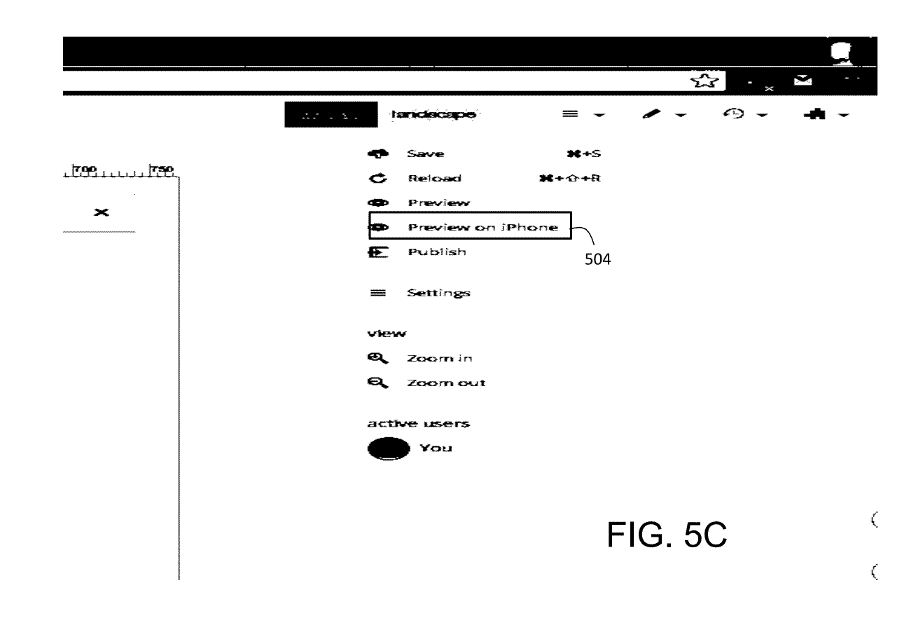

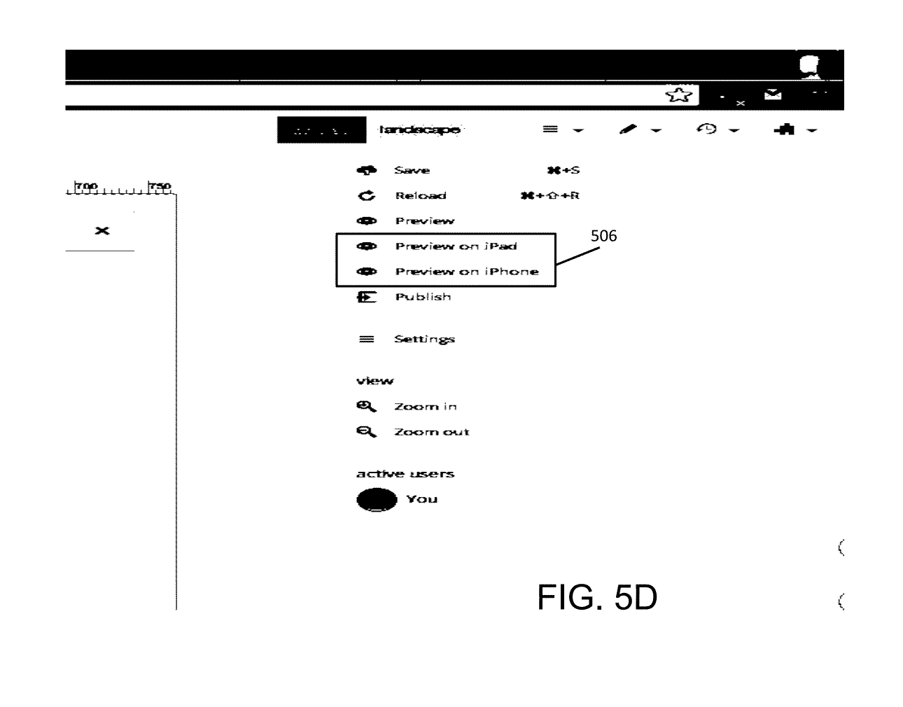

In an embodiment of the present disclosure, as described above, the platform having the user interface 212 having the set of tools 214 integrate the mutually different communication devices 108-112 into workflow process as preview devices. This integration allows the user 104 to control view previews directly from the communication devices 102 through the browser. For example, the user 104 is able to preview the ad content on the communication device 102 which will be published on different group of communication devices 108-112. To preview the ad content, the user 104 needs to register the different communication devices 108-112. For example, if the user 104 wants to preview different ad content having different ad formats for an android-based phone having a particular screen size and particular hardware components, for example the communication device 108, the user 104 registers the communication device 108 on the platform. FIG. 5A illustrates a snapshot of the platform indicating that no communication device is registered. FIG. 5B, FIG. 5C and FIG. 5D are illustrations a of sample snapshots of the platform showing registration of different communication devices (shown as a block 502, block 504 and a block 506 in the FIG. 5B, FIG. 5C and FIG. 5D respectively. In an embodiment of the present disclosure, the translation module 210 is operable to simulate different communication devices 108-112 from rendering tests performed on one or more actual examples of the different communication devices 108-112. The platform implements the rendering tests by performing physical image capture of each of the physical displays of the different communication devices 108-112 and/or by performing a screen graphics capture of display data to be output to the physical displays of each of the respective different communication devices 108-112.

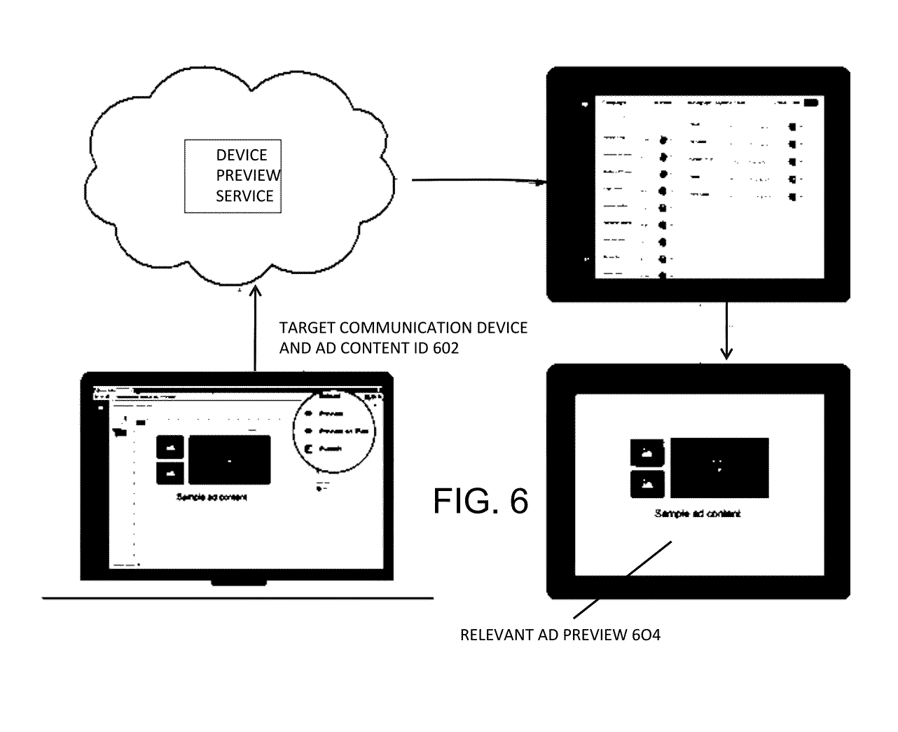

In another embodiment of the present disclosure, once the user 104 registers the communication device 108, as shown in sample screen shots in FIG. 6, the user 104 can preview different ad contents and different ad formats on the communication device 108. The user 104 provides the target communication device, for example the communication device 108, and ad content ID 602 for which he/she wants to have a look. The device preview service of the platform enables the user 104 to have a look at the relevant ad preview 604.

It will be appreciated that the platform can enable the registration of each of the different communication devices 108-112 by using socket service or other technologies presently known in the art and which are adapted to the configuration of the communication device 102. Similarly, the platform enables the ad content preview on different communication devices 108-112 as per the technologies presently known in the art.

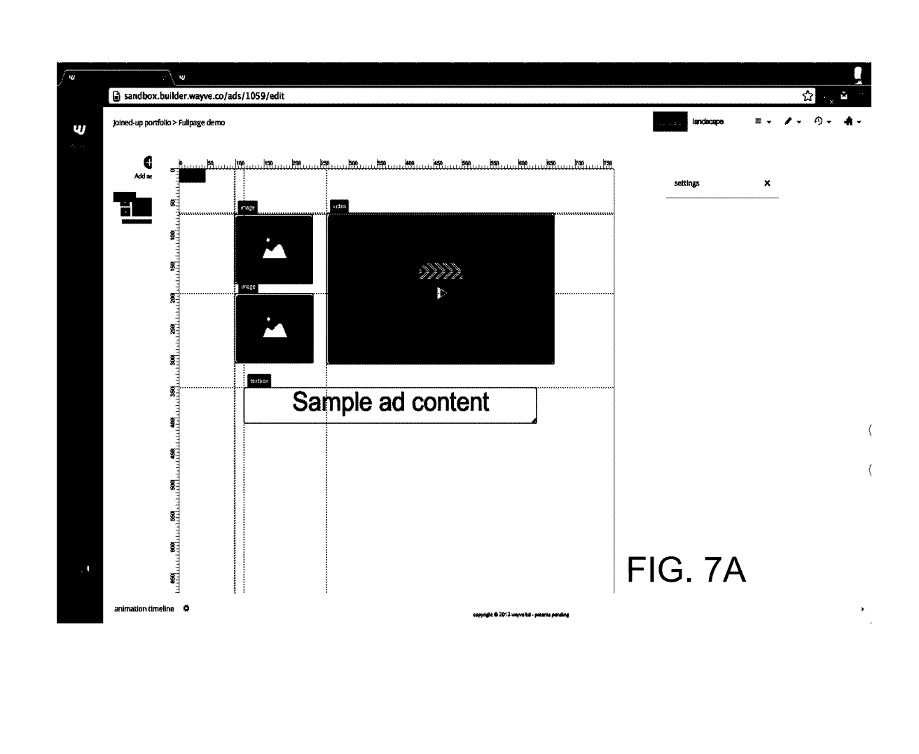

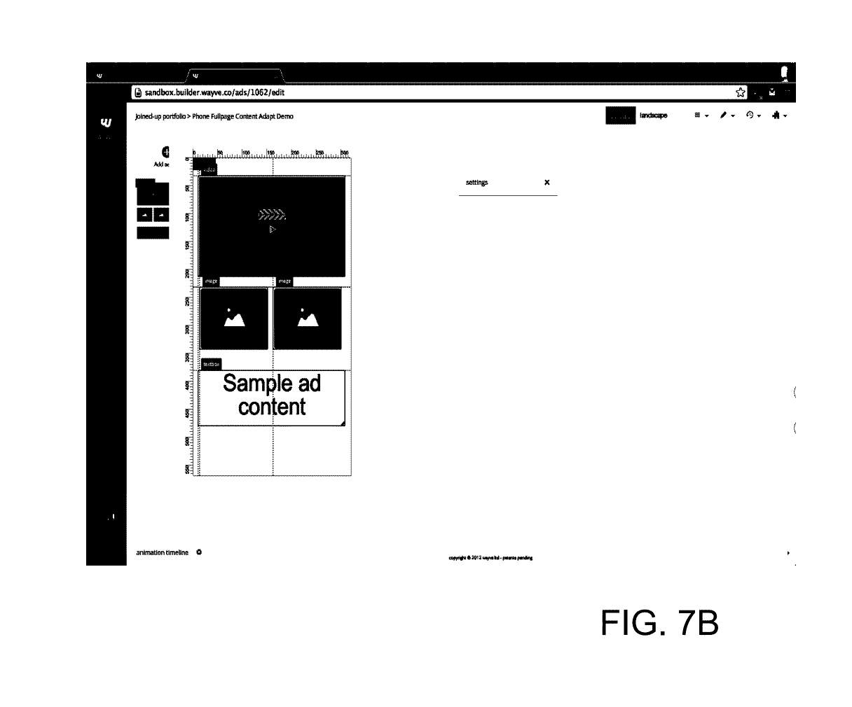

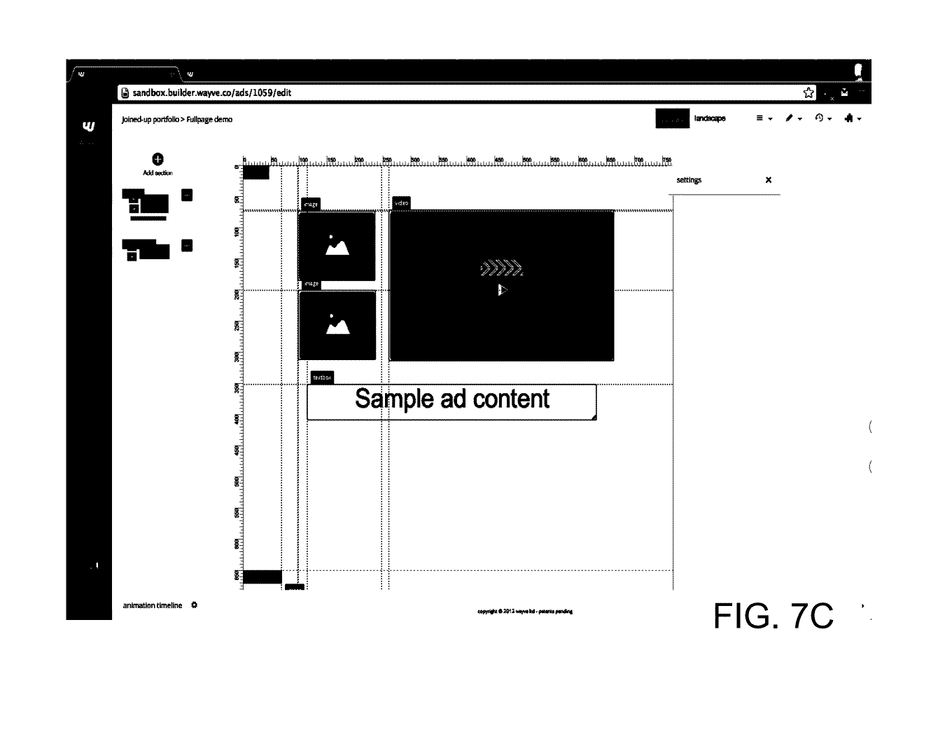

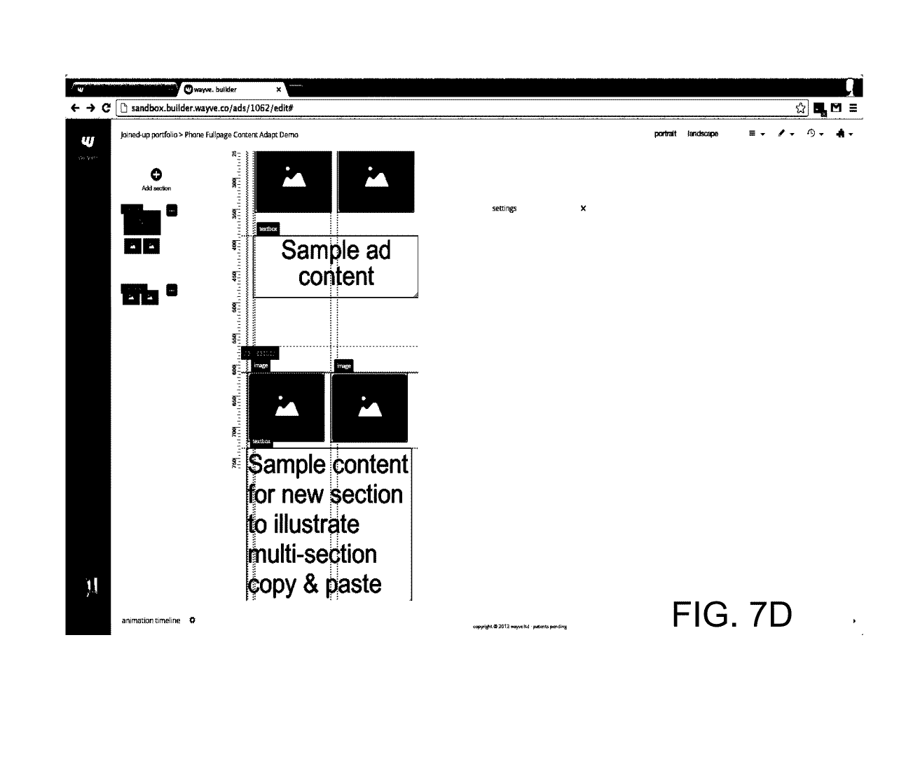

In yet another embodiment of the present disclosure, as mentioned above, the platform intelligently repositions pasted objects for differing screen sizes/browser resolutions of the different communication devices 108-112. For example, as shown in a sample screenshot provided in FIG. 7A, the user 104 selects the content to be repurposed and copies to browser's clipboard. Now, as shown in the sample screen shot provided in FIG. 7B, the content is pasted from browser's clipboard onto destination canvas and is intelligently re-arranged by the platform itself to suit the canvas size, for example screen size/browser resolution. The user 104 can then adjust the layout if required. In an embodiment of the present disclosure, as shown in the sample screenshot of the FIG. 7C, multiple content sections can be selected and copied to browsers clipboard. Accordingly, as shown in the sample screenshot provided in FIG. 7D, multiple content sections are pasted from browser clipboard to destination canvas with assets being intelligently adapted.

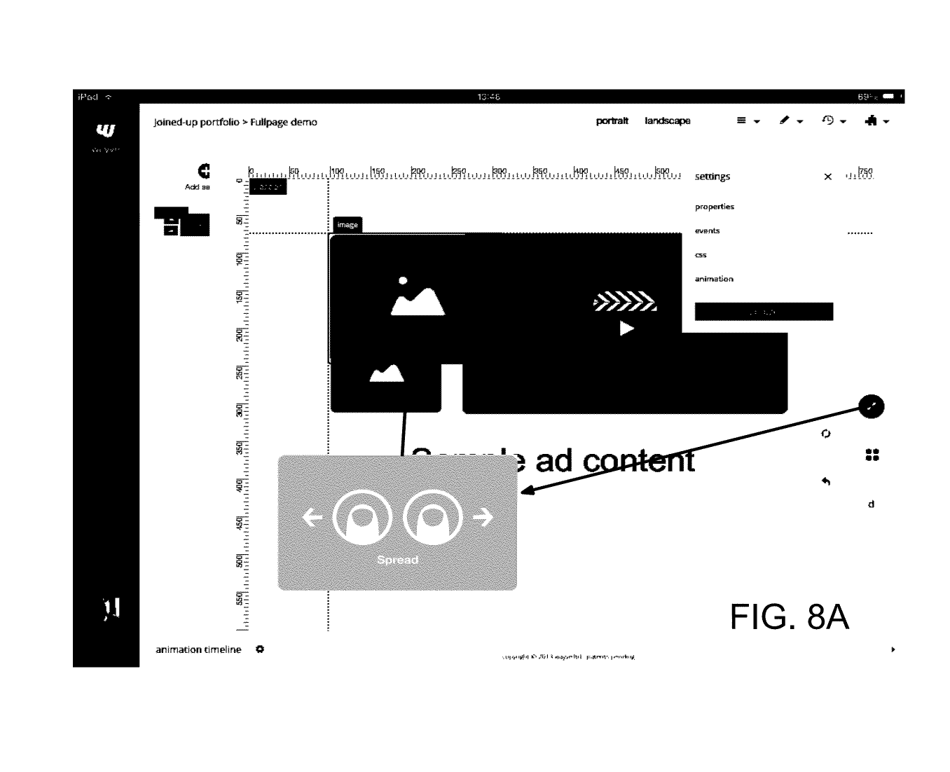

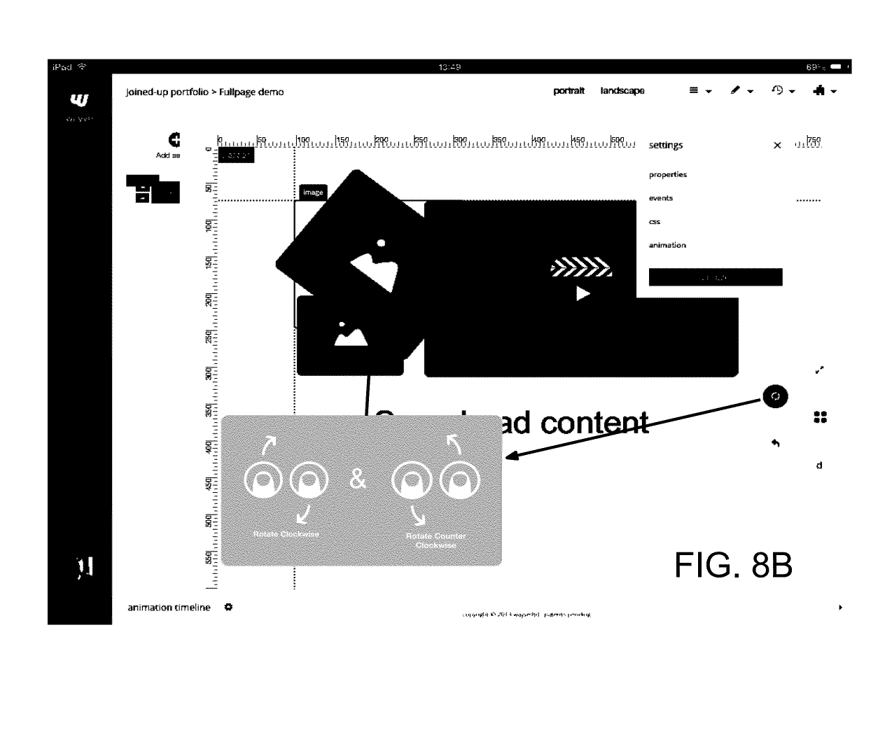

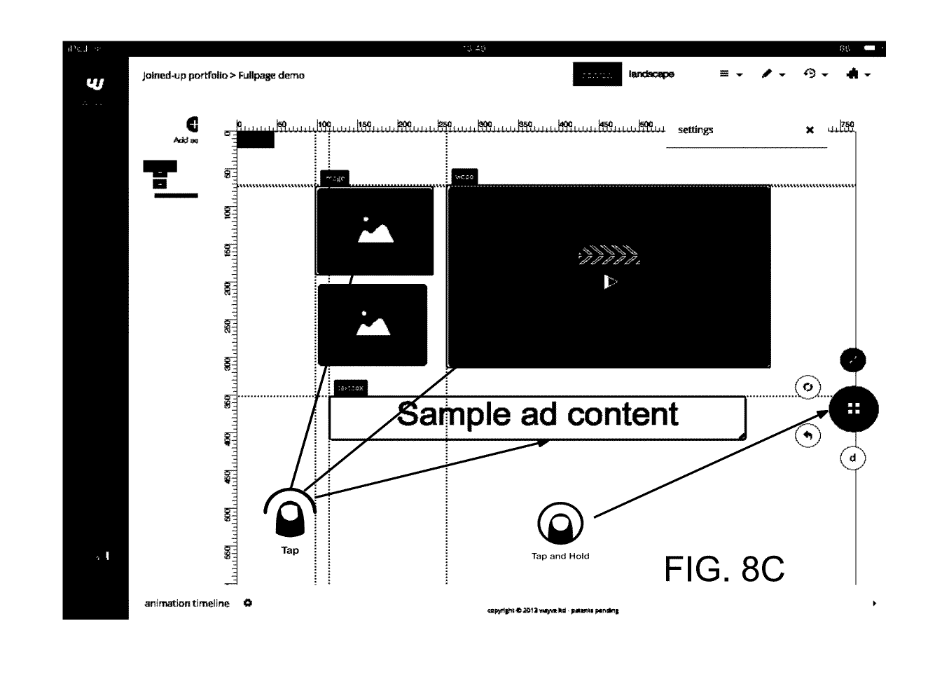

In yet another embodiment of the present disclosure, as mentioned above and shown in the sample screen shots provided in FIG. 8A, FIG. 8B and FIG. 8C, the platform can contextually display component actions menu on devices which have touch capabilities, for example the communication device 110. The display component actions menu is tailored for each component. For example, as shown in the sample screen shot provided in FIG. 8A, when a scale mode is selected, the platform enables pinch gesture to resize component object. Similarly, as shown in the sample screen shot of the FIG. 8B, when a rotate mode is selected, the touch screen of the communication device 102 enables a two finger turn to rotate component object clockwise/anti-clockwise. On the same lines, as shown in the sample screen shot provided in FIG. 8C, the platform enables selection of components by taping and holding.

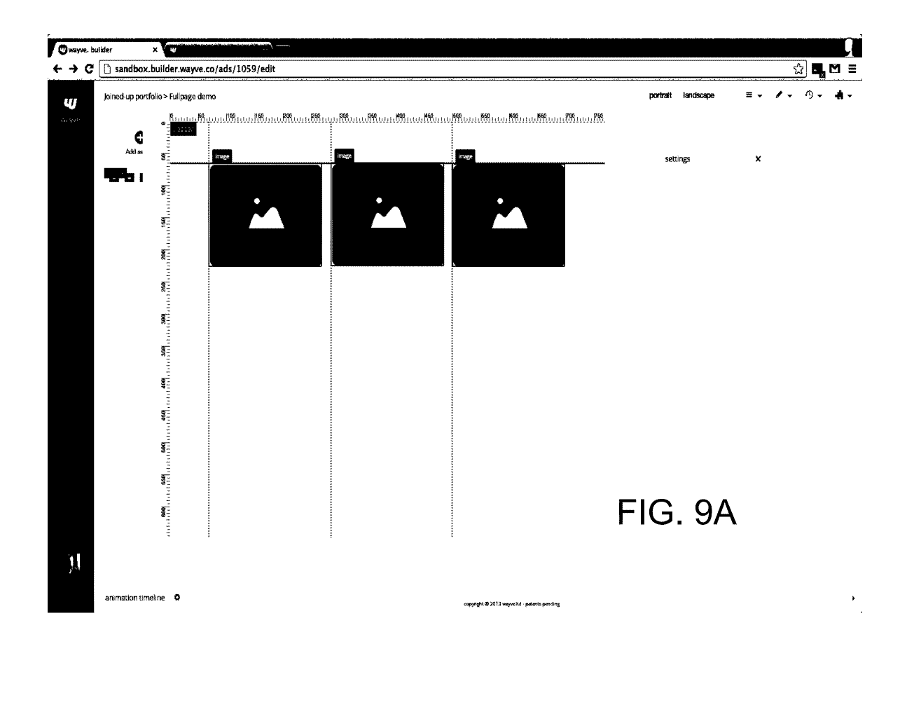

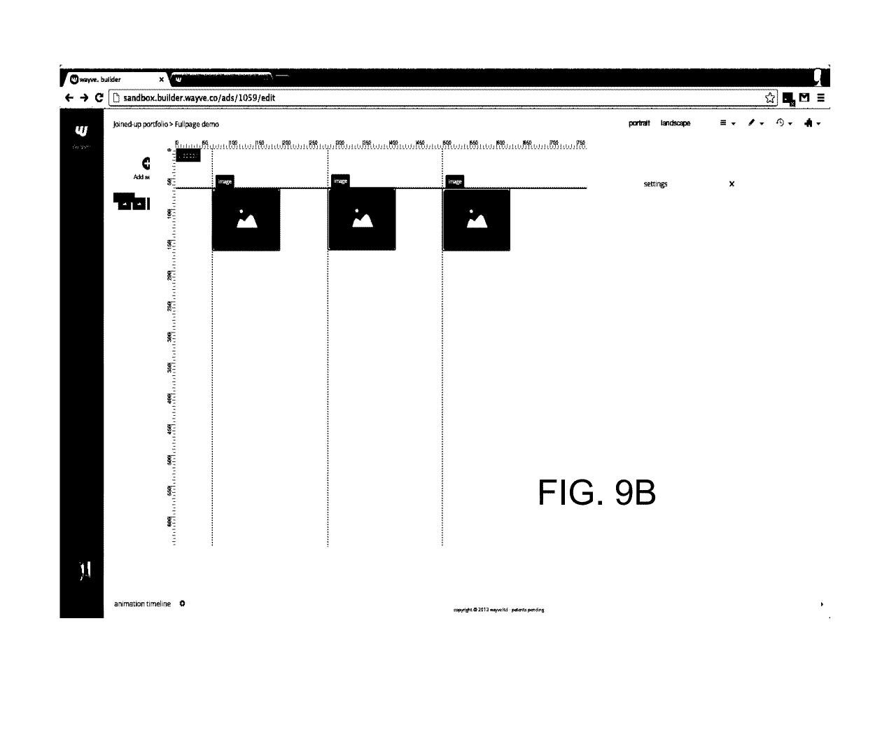

In yet another embodiment of the present disclosure, as mentioned above and shown in the sample screen shots provided in FIG. 9A, FIG. 9B and FIG. 9C, the platform enables the ability to edit layout of an individual/multiple component objects on the canvas. For example, as shown in the sample screenshot provided in FIG. 9A and FIG. 9B, the platform enables the multiple selected items to be resized as a group. Similarly, as shown in the sample screenshot provided in FIG. 9C, the platform enables automatic updating of animation properties for selected components when the components are re-positioned on the canvas.

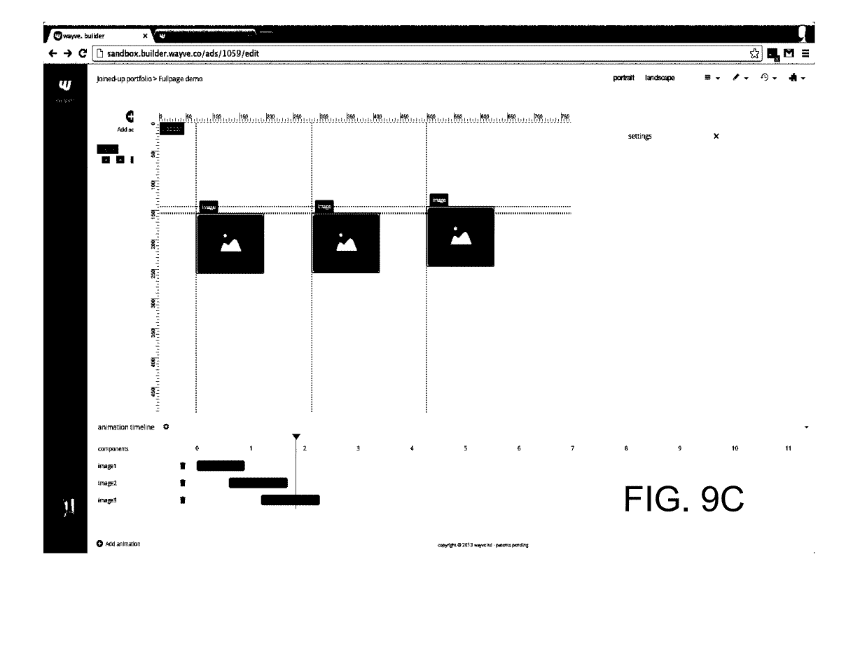

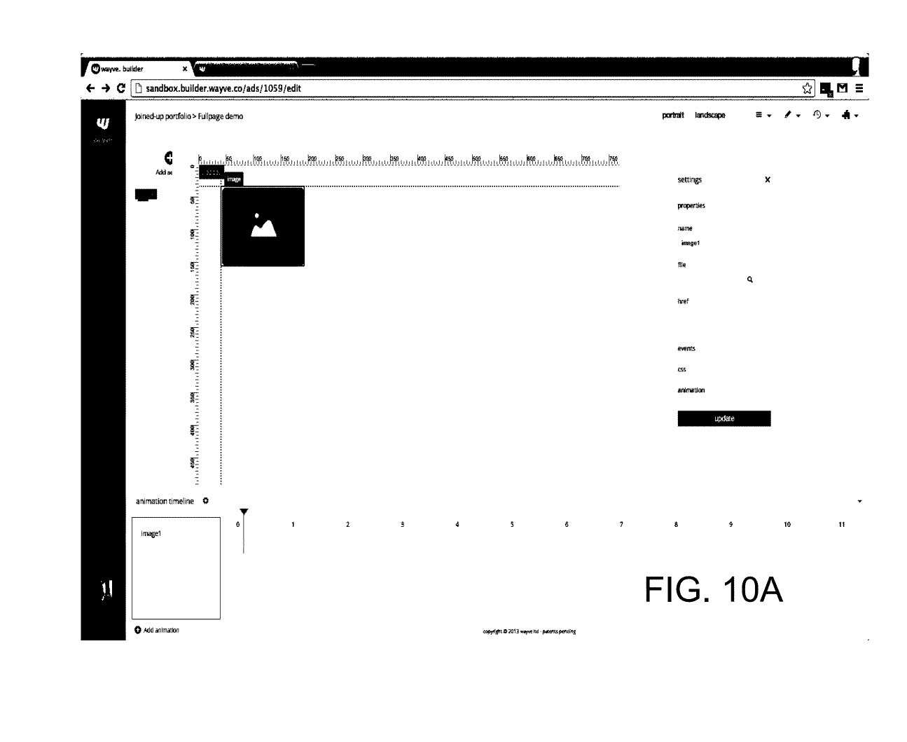

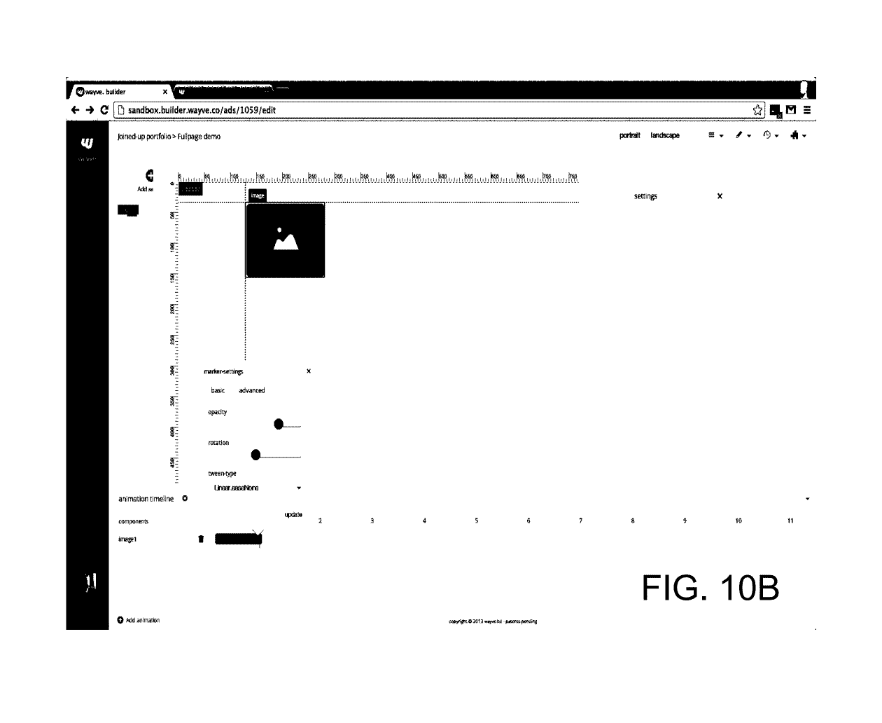

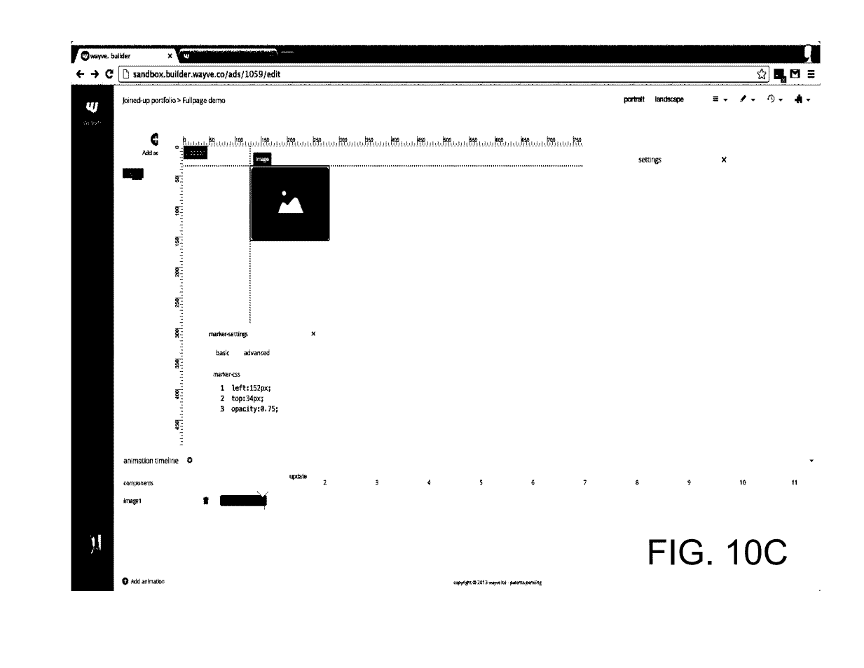

In yet another embodiment of the present disclosure, as mentioned above and shown in the sample screen shots provided in FIG. 10A, FIG. 10B and FIG. 10C, the platform enables the ability to animate elements via a timeline user interface. For example, as shown in the sample screenshot provided in FIG. 10A, the platform enables the user 104 to create animation timeline instance for component. Similarly, as shown in the sample screenshot provided in FIG. 10B, the platform enables the user 104 to adjust settings for each marker by dragging with mouse cursor/using directional cursor keys to reposition component object and settings panel. Accordingly, animation settings for each marker can be adjusted. On the same lines, as shown in the sample screenshot provided in FIG. 10C, the platform provides the user 104 an option to use an advanced mode to create custom animations.

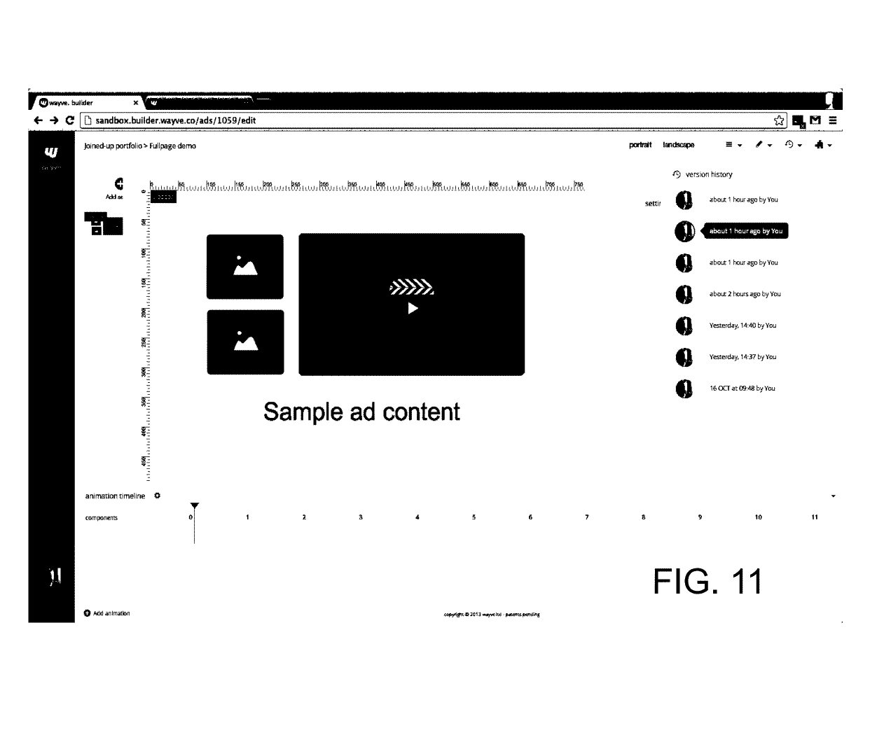

In yet another embodiment of the present disclosure, as shown in the sample screenshot provided in FIG. 11, the platform enables the user 104 with an ability to load shared versions provided by other users, using the platform, or rollback to previously created versions.

The method and system of the present disclosure has many advantages over the prior art. The above explained method and system not only makes the process of authoring, testing and trafficking ad content far simpler through process innovations but also unifies the workflow process for producing ad content across desktop, mobile and future smart TV platforms. In addition, unlike existing mobile advertising toolsets, the method and system explained above explained is not restricted by a template system for content. The aforementioned method and system give designers, and authors complete freedom regarding layout for each responsive state. Moreover, the set of tools described in the foregoing not only allows pure play designers to author rich advertising content, but also substantially cuts a time required to perform fundamental workflow tasks including automatically optimizing layered graphics editing files, for example regarding purposing content for different screen to reduce the overall time required for production and streamlining native device testing. Moreover, the set of tools automatically adapts the code to suit individual publishing technologies/environments at the point of being trafficked, thereby substantially reducing workflow time.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for generating device-optimized content from source data, wherein the system includes computing hardware which is operable to execute one or more software products for providing a graphical user interface for enabling user-manipulation of the source data to generate intermediate content, wherein the system includes a translation arrangement for translating the intermediate content to the device-optimized content which takes into account rendering characteristics of one or more wireless-enabled portable rendering devices on which the device-optimized content is to be rendered.

2. A system as claimed in claim 1, wherein that the source data includes camera-captured images of real scenes and/or real objects.

3. A system as claimed in claim 1, wherein the system is operable to present on the graphical user interface one or more simulated renderings of the device-optimized content, wherein the one or more simulated renderings employ the translation arrangement for their generation.

4. A system as claimed in claim 3, wherein the system is operable to adapt the translation arrangement to simulate the one or more devices from rendering tests performed on one or more actual examples of the one or more devices.

5. A system as claimed in claim 4, wherein the system is operable to implement the rendering tests by performing physical image capture of one or more physical displays of the one or more devices and/or by performing a screen graphics capture of display data to be output to the physical displays of the one or more devices.

6. A system as claimed in claim 5, wherein translation arrangement is automatically updated from the rendering tests.

7. A system as claimed in claim 1, wherein the system is operable to generate the graphical user interface to provide a free-design graphical interface environment for entering the source data.

8. A system as claimed in claim 7, wherein the system is operable to provide on the free-design graphical interface a “drag-and-drop” functionality for manipulating the source data.

9. A system as claimed in claim 1, wherein the system is operable to accommodate the source data input as Adobe Flash content and/or HTML content.

10. A system as claimed in claim 1, wherein the translation arrangement is operable to generate software applications with embedded content for presentation as the device-optimized content.

11. A system as claimed claim 1, wherein the system is operable to unify advert generation from the source data across a plurality of presentation platforms represented by the one or more devices.

12. A system as claimed in claim 11, wherein the system is operable to perform repurposing of screen content for the different presentation platforms.

13. A system as claimed in claim 1, wherein the system automatically provides for implementing tracking events and complete advertisements as the device-optimized content.

14. A system as claimed in claim 1, wherein the system is operable to optimize the source data automatically into JPG and/or PNG formats.

15. A system as claimed in claim 1, wherein the system is operable to allow workflow processes for simulated preview devices, for enabling users to control previews directly from a desktop environment provided at the graphical user interface.

16. A system as claimed in claim 1, wherein the system is operable intelligently to reposition objects on differing screen sizes and/or for differing browser resolution associated with the one or more devices.

17. A system as claimed claim 1, wherein the system is operable on the graphical user interface to accommodate editing of one or more layouts of individual and/or multiple components on design canvas when generating the device-optimize content.

18. A method of generating device-optimized content from source data, wherein the method includes using a system comprising computing hardware which is operable to execute one or more software products for providing a graphical user interface for enabling user-manipulation of the source data to generate intermediate content, the method comprising:
using a translation arrangement of the system for translating the intermediate content to the device-optimized content which takes into account rendering characteristics of one or more wireless-enabled portable rendering devices on which the device-optimized content is to be rendered.

19. A method as claimed in claim 18, wherein the method includes utilizing for the source data camera-captured images of real scenes and/or objects.

20. A method as claimed in claim 18, further comprising:
presenting on the graphical user interface one or more simulated renderings of the device-optimized content, wherein the one or more simulated renderings employ the translation arrangement for their generation.

21. A method as claimed in claim 20, further comprising:
adapting the translation arrangement to simulate the one or more devices from rendering tests performed on one or more actual examples of the one or more devices.

22. A method as claimed in claim 21, further comprising:
implementing the rendering tests by performing physical image capture of one or more physical displays of the one or more devices and/or by performing a screen graphics capture of display data to be output to the physical displays of the one or more devices.

23. A method as claimed in claim 22, further comprising:
automatically updating the translation arrangement from the rendering tests.

24. A method as claimed in claim 18, further comprising:
using the system to generate the graphical user interface to provide a free-design graphical interface environment for entering the source data.

25. A method as claimed in claim 24, further comprising:
operating the system to provide on the free-design graphical interface a “drag-and-drop” functionality for manipulating the source data.

26. A method as claimed in claim 18, further comprising:
using the system to accommodate the source data input as Adobe Flash content and/or HTML content.

27. A method as claimed in claim 18, further comprising:
operating the translation arrangement to generate software applications with embedded content for presentation as the device-optimized content.

28. A method as claimed in claim 18, further comprising:
unifying advert generation from the source data across a plurality of presentation platforms representing the one or more devices.

29. A method as claimed in claim 28, further comprising:
performing repurposing of screen content for the different presentation platforms.

30. A method as claimed in claim 18, further comprising:
automatically implementing tracking events and complete advertisements as the device-optimized content.

31. A method as claimed in claim 18, further comprising:
using the system to optimize the source data automatically into JPG and/or PNG formats.

32. A method as claimed in claim 18, further comprising:
allowing workflow processes for simulated preview devices, for enabling users to control previews directly from a desktop environment provided at the graphical user interface.

33. A method as claimed in claim 18, further comprising:
intelligently repositioning objects on differing screen sizes and/or for differing browser resolution associated with the one or more devices.

34. A method as claimed in claim 18, further comprising:
operating the system for accommodating on the graphical user interface editing of one or more layouts of individual and/or multiple components on design canvas when generating the device-optimize content.

35. A software product recorded on non-transient machine-readable data storage media, wherein the software product is executable upon computing hardware for implementing a method as claimed in claim 18.
